(19) United States
(12) Patent Application Publication
(10) Pub. No.: US 2025/0057636 A1
(43) Pub. Date: Feb. 20, 2025

(54) DENTAL IMPLANT IRRIGATION

(71) Applicant: Irriguide, LLC, Barrington, IL (US)

(72) Inventors: Thomas F. Jackson, Barrington, IL (US); Ryan Jackson, Inverness, IL (US); Scott W. Beu, Bolingbrook, IL (US); Ronaldo J. Santiago, South Elgin, IL (US)

(73) Assignee: Irriguide, LLC, Barrington, IL (US)

(21) Appl. No.: 18/665,180

(22) Filed: May 15, 2024

Related U.S. Application Data
(63) Continuation-in-part of application No. 18/499,194, filed on Oct. 31, 2023.
(60) Provisional application No. 63/467,310, filed on May 17, 2023.

(51) Int. Cl. A61C 8/00; A61C 17/02

(52) U.S. Cl. CPC A61C 8/009; A61C 17/02

(57) ABSTRACT

An installation tool, which is for connecting an irrigation guide to a dental implant surgical template, includes a receptacle having a first opening, a handle frangibly connected to the receptacle, a threaded projection having a second opening and extending axially from the receptacle, and a passageway extending between the first opening of the receptacle and the second opening of the threaded projection. The threaded projection may be configured to threadably engage an irrigation passage in the dental implant surgical template. The passageway may include a first interface surface that is configured to engage a second interface surface of the irrigation guide to frictionally secure the irrigation guide within the passageway.

### CROSS REFERENCE TO RELATED APPLICATIONS

This application claims the benefit of U.S. Provisional Patent Application No. 63/467,310, filed on May 17, 2023, and U.S. Non-Provisional patent application Ser. No. 18,499,194, filed on Oct. 31, 2023, the entire contents of all of the foregoing are hereby incorporated by reference herein.

### BACKGROUND

The present disclosure relates to apparatus and methods for providing irrigation during dental implant procedures.

The dental implant osteotomy process involves making incisions into a patient's gums to expose the underlying bone of the upper or lower jaw. One or more holes are then drilled into the bone such that dental implant posts can be inserted therein. In a successful dental implant osteotomy process, the bone surrounding the implant recovers and grows around the implant such that the implant becomes osseointegrated. Artificial dentures or other dental devices may then be secured to the implant.

It has been found that one key to successful dental implant surgery is maintaining the temperature of the bone, into which the implantation holes are being drilled, below 47 degrees Celsius. It is believed that temperatures in excess of 47 degrees C. for extended durations of time, e.g. more than approximately 1 minute, result in bone necrosis, which may prevent the bone from recovering and osseointegrating around the implant after the implant has been inserted into the hole.

### SUMMARY

In some aspects, a kit for irrigating a dental implant surgical template is provided, the surgical template may include a guide chamber adapted to receive a surgical drill, and the kit may comprise a drill bit including a cutting tip, a shank, and an interface profile between the tip and the shank. The tip may be configured to form an irrigation passage in the surgical template that communicates with the guide chamber, and the interface profile may be configured to form a first interface surface on the surgical template. An irrigation guide may include a second interface surface, a coupling end, and an irrigation channel extending between the second interface surface and the coupling end. The second interface surface may be engageable with the first interface surface to secure the irrigation guide to the first interface surface and to place the irrigation channel into fluid communication with the irrigation passage. The coupling end may be couplable to a source of irrigation fluid for providing irrigation fluid to the irrigation channel and the guide chamber.

The second interface surface may fit within the first interface surface to secure the irrigation guide to the first interface surface. The first interface surface may define a cylinder and the second interface surface may be tapered such that the second interface surface fits snugly within the cylinder when the second interface surface is inserted into the cylinder. The first interface surface may define a countersink surrounding the irrigation passage and the second interface surface may define a cylinder, and the cylinder may be insertable into the countersink. The countersink may be frusto-conical and the cylinder may be a conical cylinder. The irrigation guide may be rotatable relative to the first interface surface. The cutting tip may include a first diameter and the interface profile may include a first stepped section having a second diameter that is larger than the first diameter, and the first stepped section may be configured to form a countersink in the surgical template surrounding and in communication with the irrigation passage. The countersink may at least partially define the first interface surface.

The interface profile may include a second stepped section having a third diameter that is larger than the second diameter. The second stepped section may be configured to form a mating surface in the surgical template surrounding the countersink, and the first interface surface may include the mating surface. The second interface surface may fit within the first interface surface to secure the irrigation guide to the first interface surface. The irrigation channel may define an input axis and an output axis, and the input axis may be angled at least about 20 degrees relative to the output axis. In other configurations the input axis and the output axis may be substantially aligned. The coupling end may include a length of rigid tubing in communication with the irrigation channel and having a distal end, and the distal end may include a retention feature for enhancing retention of the source of irrigation fluid to which the coupling end is coupleable. The coupling end may be angled relative to the first end, and the irrigation guide may be rotatable within the passageway to permit orientation of the coupling end relative to the first end.

The irrigation guide may include an insertion end surrounding an exit of the irrigation channel and at least partially defining the second interface surface, and the insertion end may include a reduced diameter portion configured for insertion into a countersink defined by the first interface surface. The rigid tubing may extend through the irrigation guide from the coupling end to the second interface surface and may least partially define the irrigation channel.

The kit may also include a surgical template. The surgical template may include at least one anchoring feature adapted for engagement with a patient's anatomy to locate the surgical template, and a guide portion coupled to the anchoring feature and including a guide sleeve defining the guide chamber.

In other aspects, an implant osteotomy kit for dental implant placement in the mouth of a patient may be provided and the kit may include a surgical template including an anchoring feature adapted for engagement with the patient's anatomy, a guide portion coupled to the anchoring feature and defining a guide chamber, an irrigation passage fluidly communicating with the guide chamber, and a first interface surface surrounding the irrigation passage. The kit may also include an irrigation guide including a second interface surface, a coupling end, and an irrigation channel extending between the second interface surface and the coupling end. The second interface surface may be engageable with the first interface surface to secure the irrigation guide to the first interface surface and to place the irrigation channel into fluid communication with the guide chamber, and the coupling end may be couplable to a source of irrigation fluid for providing irrigation fluid to the guide chamber by way of the irrigation channel.

The first interface surface may define a cylinder surrounding the irrigation passage and the second interface surface may be tapered such that the second interface surface fits snugly within the cylinder when the second interface surface is inserted into the cylinder. The first interface surface may define a countersink surrounding the irrigation passage and the second interface surface may define a cylinder, and the cylinder may be insertable into the countersink. The countersink may be frusto-conical and the cylinder may be a conical cylinder. The first interface surface may include a mating surface surrounding the countersink. The second interface surface may fit within the first interface surface to secure the irrigation guide to the surgical template. The irrigation channel may define an input axis and an output axis, and the input axis may be angled at least about 20 degrees relative to the output axis. In other configurations the output axis and the input axis may be substantially aligned. The coupling end may include a length of rigid tubing in communication with the irrigation channel and having a distal end, and the distal end may include a retention feature for enhancing retention of the source of irrigation fluid to which the coupling end is couplable. The rigid tubing may extend through the irrigation guide from the coupling end to the second interface surface and may at least partially define the irrigation channel.

The irrigation guide may include an insertion end surrounding an exit of the irrigation channel and at least partially defining the second interface surface, and the insertion end may include a reduced diameter portion configured for insertion into a countersink defined by the first interface surface.

The kit may also include a drill bit including cutting tip, a shank, and an interface profile between the tip and the shank that may be configured to form the first interface surface on the surgical template.

The irrigation passage may define an irrigation axis, and when the second interface surface is engaged with the first interface surface the irrigation guide may be rotatable relative to the surgical template about the irrigation axis.

In other aspects, a method of irrigating an osteotomy site is provided and includes providing a surgical template including an anchoring feature adapted for engagement with the patient's anatomy, and a guide portion coupled to the anchoring feature and defining a guide chamber. The method also includes forming an irrigation passage fluidly communicating with the guide chamber, and a first interface surface surrounding the irrigation passage. The method also includes providing an irrigation guide including a second interface surface, a coupling end, and an irrigation channel extending between the second interface surface and the coupling end. The method also includes engaging the second interface surface with the first interface surface to secure the irrigation guide to the first interface surface and to place the irrigation channel into fluid communication with the guide chamber. The method also includes coupling the coupling end to a source of irrigation fluid to deliver irrigation fluid to the guide chamber via the irrigation channel.

The method may further include rotating the irrigation guide relative to the surgical template about an irrigation axis defined by the irrigation passage to locate the coupling end relative to the surgical template. The method may further include securing the second interface surface to the first interface surface with adhesive.

The method may further include providing a drill bit including a cutting tip, a shank, and an interface profile between the tip and the shank, and using the drill bit to form the irrigation passage and the first interface surface. After engaging the second interface surface with the first interface surface, an insertion end of the irrigation guide may extend through the surgical guide and into the guide chamber, and the method may further include grinding away a portion of the insertion end that is located within the guide chamber until an end of the insertion end is substantially flush with a wall of the guide chamber.

In other aspects, an installation tool for connecting an irrigation guide to a dental implant surgical template may be provided. The installation tool may include a receptacle having a first opening, a handle frangibly connected to the receptacle, a threaded projection having a second opening and extending axially from the receptacle, and a passageway extending between the first opening of the receptacle and the second opening of the threaded projection. The threaded projection may be configured to threadably engage an irrigation passage in the dental implant surgical template. The passageway may include a first interface surface that is configured to engage a second interface surface of the irrigation guide to frictionally secure the irrigation guide within the passageway.

The handle may include a frangible member having a first angled surface converging toward a second angled surface. The handle may include a handle body having a central aperture, and the frangible member may project inwardly from the central aperture toward the receptacle. The receptacle may include a first arcuate member and a second arcuate member that are radially spaced apart to define an indentation therebetween. The frangible member may be connected to the receptacle at a location within the indentation. The receptacle may include a shoulder that tapers away from an end surface of the receptacle to form a ledge, the frangible member may be connected to a side surface of the receptacle at a location above the ledge. The frangible member may axially project from a handle surface that faces the receptacle and frangibly connect to a receptacle surface that faces the handle.

In other aspects, a kit for irrigating a dental implant surgical template may be provided. The dental implant surgical template may include a guide chamber adapted to received a surgical drill, and an irrigation passage communicating with the guide chamber. The kit may include an installation tool and an irrigation guide. The installation tool may include a receptacle having a first opening, a handle frangibly connected to the receptacle, a projection having a second opening and extending axially from the receptacle, and a passageway providing fluid communication between the first opening and the second opening. The projection may be configured to engage the irrigation passage. The passageway may include a first interface surface. The irrigation guide may include a first end including a second interface surface, a coupling end opposite the first end, and an irrigation channel extending between the first end and the coupling end. The second interface surface may be engageable with the first interface surface to secure the irrigation guide to the first interface surface and to place the irrigation channel into fluid communication with the guide chamber. The coupling end may be coupleable to a source of irrigation fluid for providing the irrigation fluid to the irrigation channel and the guide chamber.

The second interface surface may fit within the first interface surface to secure the irrigation guide to the first interface surface. The passageway may communicate with the irrigation passage when the projection is engaged with the irrigation passage. The coupling end may include a length of rigid tubing in communication with the irrigation channel. The rigid tubing may include a retention feature at a distal end thereof. The handle may be frangibly connected to the receptacle of the installation tool body via a frangible member that includes a first angled surface converging towards a second angled surface. The projection may include an outer threaded surface that is sized and shaped to permit the installation tool to be threadably inserted into and held within the irrigation passage.

The kit may further include a second installation tool. The second installation tool may include a second receptacle having a second receptacle first opening, a second handle frangibly connected to the second receptacle, a second projection having a second projection second opening and extending axially from the second receptacle, and a second passageway extending between the second receptacle first opening and the second projection second opening. The second projection may be configured to engage a second irrigation passage in the dental implant surgical template that communicates with a second guide chamber of the dental implant surgical template

The kit may further include the dental implant surgical template. The dental implant surgical template may further include at least one anchoring feature adapted for engagement with anatomy of a patient and a second guide chamber adapted to receive the surgical drill. In other aspects, a method of irrigating at least one osteotomy site may be provided. The method may include providing a dental implant surgical template. The dental implant surgical template may include an anchoring feature adapted for engagement with anatomy of a patient, and a guide portion coupled to the anchoring feature and defining a guide chamber. The method may further include providing an installation tool. The installation tool may include a receptacle having a first opening, a handle frangibly connected to the receptacle, a projection having a second opening and extending axially from the receptacle, and a passageway extending between the first opening and the second opening. The passageway may include a first interface surface. The method may further include providing an irrigation guide. The irrigation guide may include a second interface surface, a coupling end, and an irrigation channel extending between the second interface surface and the coupling end. The method may further include forming an irrigation passage in the dental implant surgical template that fluidly communicates with the guide chamber. The method may further include inserting the projection into the irrigation passage to secure the installation tool to the dental implant surgical template. The method may further include inserting the irrigation guide into the passageway of the installation tool to engage the second interface surface with the first interface surface and to place the irrigation channel into fluid communication with the guide chamber. The method may further include coupling the coupling end to a source of irrigation fluid to deliver the irrigation fluid to the guide chamber via the irrigation channel.

Inserting the projection into the irrigation passage may include rotating the handle of the installation tool. The method may further include frictionally securing the irrigation guide to the dental implant surgical template. The method may further include providing a drill bit. Forming the irrigation passage may include forming the irrigation passage using the drill bit.

The dental implant surgical template may further include a second guide portion coupled to the anchoring feature and defining a second guide chamber. The installation tool may be a first installation tool. The passageway may be a first passageway. The method may further include forming a second irrigation passage in the dental implant surgical template that fluidly communicates with the second guide chamber. The method may further include providing a second installation tool. The second installation tool may include a second receptacle, a second handle frangibly connected to the second receptacle, a second projection extending axially from the second receptacle, and a second passageway extending through the second receptacle and the second projection. The method may further include inserting the second projection into the second irrigation passage to place the second passageway into fluid communication with the second guide chamber. The method may further include removing the irrigation guide from the first passageway of the first installation tool. The method may further include inserting the irrigation guide into the second passageway to place the irrigation channel into fluid communication with the second guide chamber. The method may further include separating the handle from the receptacle of the installation tool by breaking at least one frangible connection therebetween.

### BRIEF DESCRIPTION OF DRAWINGS

FIG. 1 is top view of a dental implant surgical template with an irrigation guide attached thereto.

FIG. 2 is a section view taken along line 2-2 of FIG. 1.

FIG. 3 is an enlarged section view showing a first embodiment of an interface between the dental implant surgical template and irrigation guide of FIG. 1

FIG. 4 is an enlarged section view showing a second embodiment of an interface between the dental implant surgical template and irrigation guide of FIG. 1.

FIG. 5 is a plan view of a drill bit for forming an irrigation passage in the dental implant surgical template of FIG. 1.

FIG. 6 is a perspective view of the irrigation guide of FIG. 1

FIG. 7 is a perspective view of another embodiment of an irrigation guide.

FIG. 8 is an end view of the irrigation guide of FIG. 7.

FIG. 9 is a section view taken along line 9-9 of FIG. 8.

FIG. 10 is a side view of another embodiment of a drill bit for forming an irrigation passage.

FIG. 11 is a perspective view illustrating a step of a method for providing irrigation to a dental implant osteotomy site.

FIG. 12 is a side view illustrating a step of a method for providing irrigation to dental implant osteotomy site.

FIG. 13 is a perspective view illustrating a step of a method for providing irrigation to a dental implant osteotomy site.

FIG. 14 is a perspective view illustrating a step of a method for providing irrigation to a dental implant osteotomy site.

FIG. 15 is a perspective view illustrating a step of a method for providing irrigation to a dental implant osteotomy site.

FIG. 16 is a perspective view illustrating a step of a method for providing irrigation to a dental implant osteotomy site.

FIG. 17 is a perspective view illustrating a step of a method for providing irrigation to a dental implant osteotomy site.

FIG. 18 is a perspective view of another embodiment of a dental implant surgical template with the irrigation guide of FIG. 7 attached thereto.

FIG. 19 is a perspective view of a first embodiment of an installation tool being provided with a dental implant surgical template and an irrigation guide.

FIG. 20 is a top view of the installation tool of FIG. 19.

FIG. 21 is a side view of the installation tool of FIG. 19 connecting the dental implant surgical template and the irrigation guide.

FIG. 22 is a section view taken along line 22-22 of FIG. 21.

FIG. 23 is a perspective view of a second embodiment of an installation tool.

FIG. 24 is a side view of the installation tool of FIG. 23 with the irrigation guide connected thereto.

FIG. 25 is a perspective view of the installation tool of FIG. 23 connecting a dental implant surgical template and an irrigation guide.

FIG. 26 is a section view taken along line 26-26 of FIG. 25.

FIG. 27 is a first perspective view of a third embodiment of an installation tool.

FIG. 28 is a second perspective view of the installation tool of FIG. 27.

FIG. 29 is a perspective view of a handle of the installation tool of FIG. 27 being used to secure the installation tool of FIG. 27 to a dental implant surgical template.

FIG. 30 is a section view of the installation tool of FIG. 27 connecting the dental implant surgical template to an irrigation guide.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

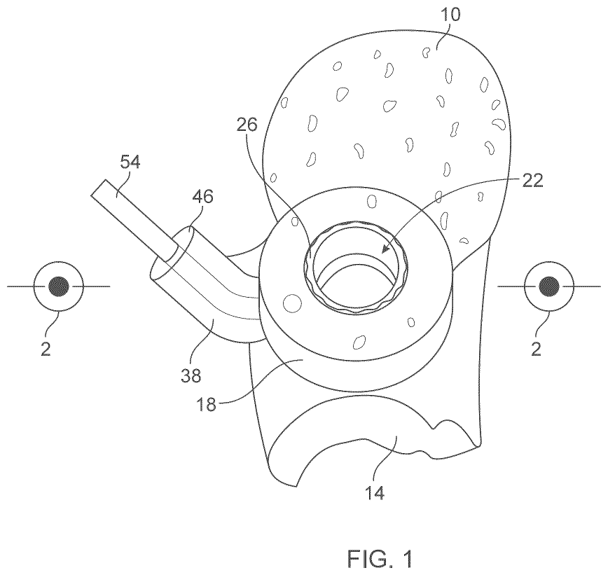

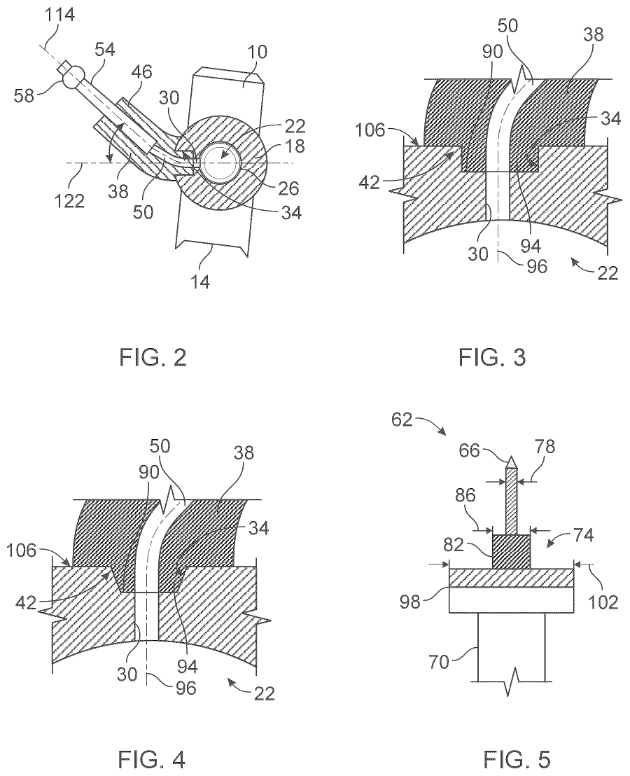

FIGS. 1 and 2 illustrate a dental implant surgical template 10 that functions as drilling guide during a dental implant procedure. The template 10 includes an anchoring feature 14 adapted for engagement with the patient's anatomy. A guide portion 18 is coupled to the anchoring feature 14 and defines a guide chamber 22 adapted to receive a surgical drill (not shown). A metallic guide sleeve 26 may be inserted into the guide chamber 22 to protect the template 10 from the surgical drill during a drilling procedure. An irrigation passage 30 (FIG. 2) is formed in the guide portion 18 and fluidly communicates with the guide chamber 22. A first interface surface 34 (FIG. 2) is formed on the guide portion 18 and surrounds the irrigation passage 30.

Referring also to FIGS. 3 and 4, an irrigation guide 38 is attached to the guide portion of the template and includes a second interface surface 42, a coupling end 46, and an irrigation channel 50 extending between the second interface surface 42 and the coupling end 46. The second interface surface 42 is engageable with, and in some configurations may fit within, the first interface surface 34 to secure the irrigation guide 38 to the first interface surface 34 and to place the irrigation channel 50 into fluid communication with the irrigation passage 30. The coupling end 46 includes a length of rigid tubing 54 (e.g., stainless steel) inserted therein that communicates with the irrigation channel 50. The illustrated tubing 54 has a distal end that includes a retention feature 58, such as a barb, flare, luer lock, or the like, for enhancing retention of a source of irrigation fluid, such as surgical tubing connected to a source of saline (not shown) to the coupling end 46. In other configurations the retention feature may be eliminated and the outer diameter of the tubing 54 may be selected to provide a snug fit with the inner diameter of the source of irrigation fluid.

The dental implant surgical template 10 and the irrigation guide 38 may be provided together in common packaging to form an implant osteotomy kit for dental implant placement in the mouth of a patient.

Referring also to FIG. 5, in some configurations an alternative kit may be provided that includes the irrigation guide 38 and a drill bit 62 that can be used to form the irrigation passage 30 and the first interface surface 34 on the guide portion of a separately provided or obtained dental implant surgical template. The drill bit 62 includes a cutting tip 66, a shank 70, and an interface profile 74 between the tip 66 and the shank 70. In use, the tip 66 is configured to form the irrigation passage 30 in the guide portion 18 of the dental implant surgical template 10, while the interface profile 74 is configured to form the first interface surface 34. In still other configurations, a kit may be provided that includes the dental implant surgical template 10, the irrigation guide 38, and the drill bit 62. In this configuration the dental implant surgical template would not be provided with an irrigation passage 30 upon delivery, rather, the recipient of the kit would use the drill bit 62 as described herein to form the irrigation passage 30 at a location on the dental implant surgical template 10 of the user's choosing.

In the illustrated configuration of FIG. 5, the cutting tip 66 has a first diameter 78 and the interface profile 74 includes a first stepped section 82 having a second diameter 86 that is larger than the first diameter 78. The first stepped section is configured to form a countersink 90 (see FIGS. 3 and 4) in the dental implant surgical template 10 that surrounds and is in communication with the irrigation passage 30. As shown, the countersink 90 at least partially defines the first interface surface 34, and the second interface surface 42 defines an output end 94 that in the illustrated configuration is in the form of a reduced-diameter cylinder that is insertable into the countersink 90. The countersink 90 and cylindrical output end 94 configuration allow the irrigation guide 38 to be rotated relative to the first interface surface 34 of the template 10 about an irrigation axis 96 defined by the irrigation passage 30 to position the coupling end 46 in a desired orientation relative to the template 10. Once the coupling end 46 is positioned as desired adhesive or other securing methods may be used. As shown in FIGS. 3 and 4, the countersink 90 and the output end 94 can take on different shapes while performing the same function. By way of example, the countersink 90 may be frusto-conical and the output end 94 may be a conical cylinder, as shown in FIG. 4.

The interface profile 74 of the drill bit 62 may also include a second stepped section 98 having a third diameter 102 that is larger than the second diameter 86, wherein the second stepped section 98 is configured to form a mating surface 106 in the dental implant surgical template 10 surrounding the countersink 90. In some configurations the mating surface 106 forms part of the first interface surface 34.

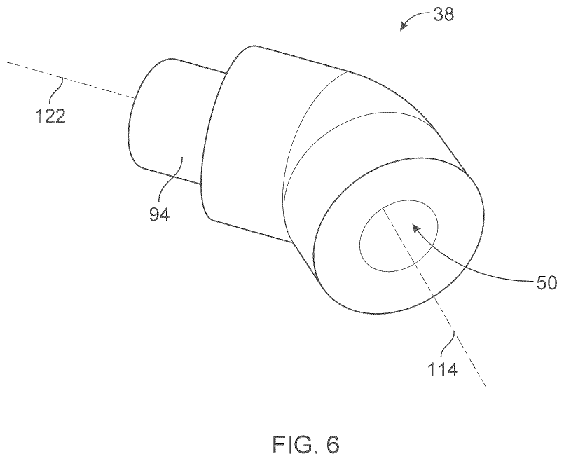

With reference also to FIG. 6, the irrigation channel 50 of the irrigation guide 38 defines an input axis 114 and an output axis 122, and the input axis 114 is angled at least about 20 degrees relative to the output axis 122. In other configurations, the input axis 114 and the output axis 122 may be substantially aligned.

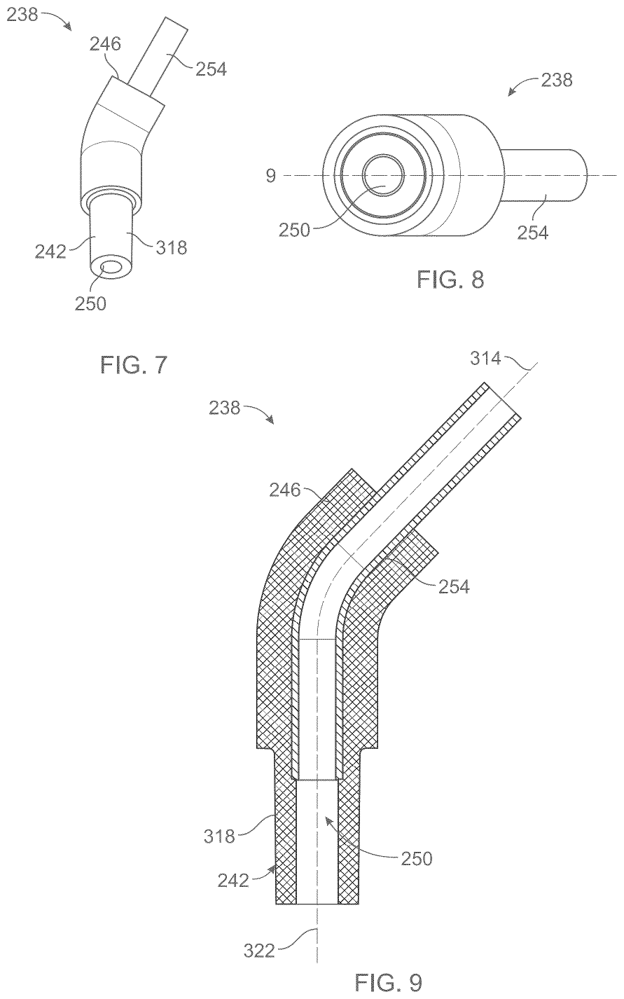

FIGS. 7-9 illustrate an alternative embodiment of an irrigation guide 238. The irrigation guide 238 includes an output end 318, a coupling end 246, and an irrigation channel 250 extending through the irrigation guide 238 and having an input end. The coupling end 246 includes a length of rigid tubing 254 (e.g., stainless steel) inserted therein that communicates with and, in the illustrated embodiment, partially defines the irrigation channel 250. In the embodiment of FIGS. 7-9 the tubing 254 extends from the coupling end 246, through the irrigation guide 238 to the output end 318, and at least partially defines the irrigation channel 250. In this way, the rigidity of the rigid tubing contributes to the overall strength of the irrigation guide 238. In some configurations the irrigation guide 238 may be formed by molding the body of the irrigation guide 238 over the tubing 254 using acrylic or other suitable material. Although not shown in FIGS. 7-9 the distal end of the tubing 254 may include a retention feature such as a barb, flare, luer lock, or the like for enhancing retention of a source of irrigation fluid.

The output end 318 of the irrigation guide 238 defines a second interface surface 242 that tapers slightly from its proximal end to its distal end, stated another way the second interface surface 242 has a conical cylindrical shape, for reasons discussed further below. The irrigation guide 238 also defines an input axis 314 and an output axis 322 that are angled at least 20 degrees relative to one another to facilitate positioning of the coupling end 246 within the patients mouth. In other configurations the input axis 314 and the output axis 322 maybe substantially aligned.

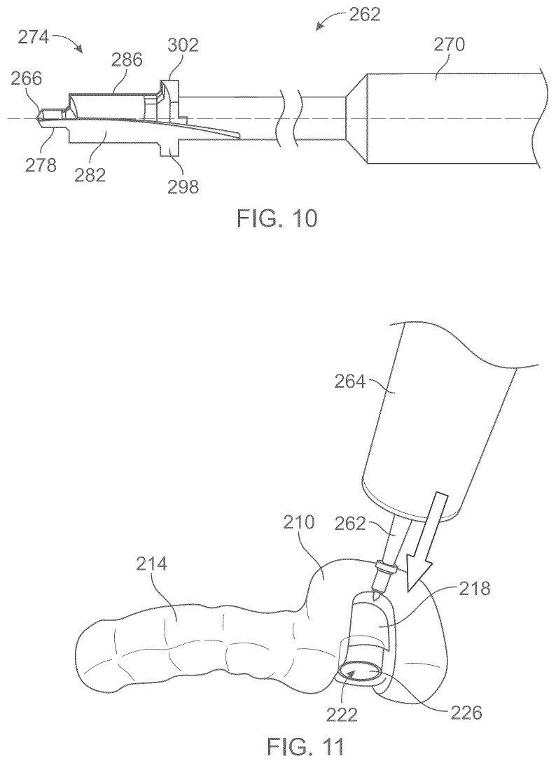

FIG. 10 illustrates an alterative embodiment of a drill bit 262 that may be used to form the irrigation passage 30, first interface surface 34, and mating surface 106. The drill bit 262 includes a cutting tip 266, a shank 270, and an interface profile 274 between the tip 266 and the shank 270. The cutting tip 266 has a first diameter 278 and the interface profile 274 includes a first stepped section 282 having a second diameter 286 that is larger than the first diameter 278. The drill bit 262 may also include a second stepped section 298 having a third diameter 302 that is larger than the second diameter 286. The dimensions and configuration of the drill bit 262 are configured to cooperate with the dimensions and configuration of the irrigation guide 238. In this regard it is contemplated that the drill bit 262 and the irrigation guide 238 may be provided as a kit that may be used by a health care professional to form an irrigation passage 30 in a dental implant surgical template 10 that is configured to receive the irrigation guide 238 for irrigating a dental implant osteotomy site or for providing irrigation in a similar way to substantially irrigate and control heat generation of any surgical site where the site may be surrounded or enclosed by a rigid template or covering that is configured to guide or otherwise assist in an osteotomy procedure.

FIGS. 11-17 illustrate a method of irrigating a dental implant osteotomy site. As shown in FIG. 11, the method includes providing a dental implant surgical template 210 including an anchoring feature 214 adapted for engagement with the patient's anatomy, and a guide portion 218 coupled to the anchoring feature 214 and defining a guide chamber 222. The guide chamber 222 may be provided with a guide sleeve 226, which may be made of metal or another durable material, to assist in guidance of the osteotomy drill bit during an osteotomy procedure as discussed further below. The drill bit 262 is attached to a rotary drill 264 and is moved toward the guide portion 218 in the direction of the arrow in FIG. 11. While the exact location of the irrigation passage 30 to be formed will vary depending on the specific application, it is generally preferred for the irrigation passage to be positioned on the guide portion between the patient's anatomy and the guide sleeve 226.

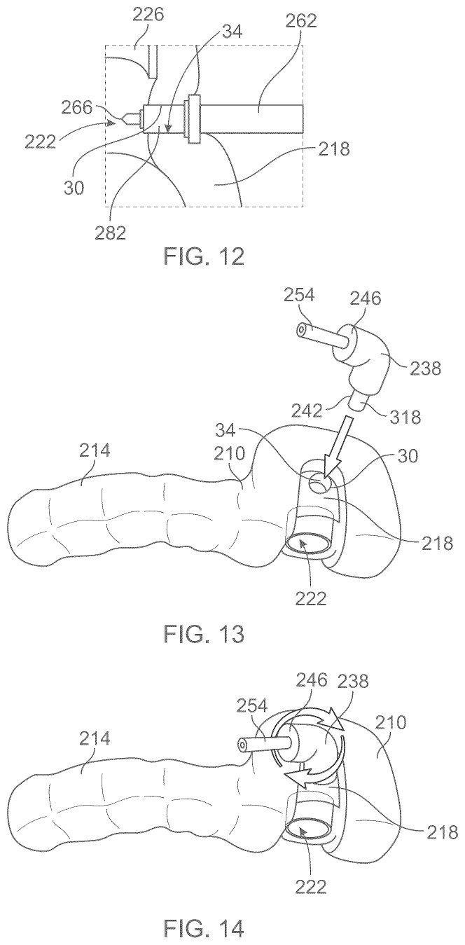

As shown in FIG. 12, the method includes using the drill bit 262 to form an irrigation passage 30 that fluidly communicates with the guide chamber 222, and a first interface surface 34 that surrounds the irrigation passage 30. In the illustrated example of FIG. 12, the thickness of the guide portion 218 is such that both the cutting tip 266 and the first stepped section 282 have passed all the way through the guide portion 218. The resulting irrigation passage 30 will therefore have a diameter that corresponds to the second diameter 286 of the drill bit 262. In other applications the thickness of the guide portion 218 may be such that only the cutting tip 266 passes all the way through the guide portion 218 resulting in an irrigation passage 30 that corresponds to the first diameter 278 surrounded by a countersink that corresponds to the second diameter 286, as shown, for example, in FIGS. 3 and 4.

As shown in FIG. 13, with the irrigation passage 30 formed in the guide portion 218 the irrigation guide 238 may be provided and the output end 318 thereof may be inserted into the irrigation passage 30 such that the second interface surface 242 is engaged with the first interface surface 34. The tapered configuration of the output end 318 allows the output end 318 to be inserted into the irrigation passage 30 until a snug but adjustable fit is achieved. With the output end 318 inserted into the irrigation passage the irrigation channel 250 of the irrigation guide 238 is placed into fluid communication with the irrigation passage 30 and the guide chamber 222 of the dental implant surgical template 210.

As shown in FIG. 14, the configuration of and interaction between the output end 318 and the first interface surface 34 is such that the irrigation guide 238 may be rotated relative to the dental implant surgical template 210 about the axis of the irrigation passage 30 to locate the coupling end 246 and the tubing 254 in a desired orientation relative to the dental implant surgical template 210, for example to facilitate easier routing of a source of irrigating fluid within the patient's mouth, or to avoid interference with implant drills or guide keys. Once the desired orientation is achieved, the location of the irrigation guide 238 and second interface surface 242 may be fixed relative to the dental implant surgical template 210 and the first interface surface 234 by applying a small amount of adhesive, for example cyanoacrylate, to the interface between the irrigation guide 238 and the dental implant surgical template 210. In other configurations the dental implant surgical template 210 and irrigation guide may be coupled or secured to one another using other methods of mechanical connection such as mechanical lock, twist lock, snap lock, or magnetic lock configurations, for example.

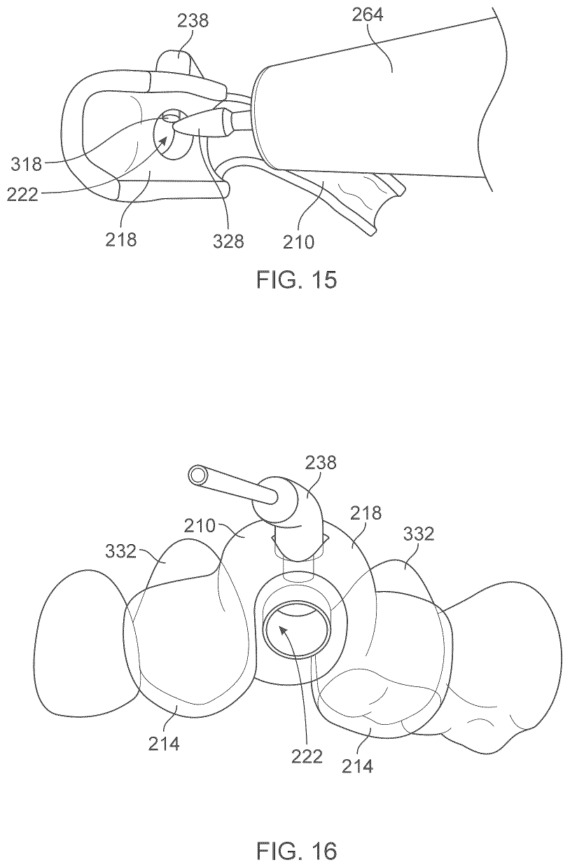

As shown in FIG. 15, in some applications, the length of the output end 318 may be greater than the thickness of the guide portion 218 such that the end of the output end 318 extends into the guide chamber 222. In such instances, to provide adequate clearance for the osteotomy drill bit, a burr 328 or similar attachment may be used in cooperation with the drill 264 to grind away the portion of the output end 318 that extends into the guide chamber 222 until the end of the output end 318 is substantially flush with the wall of the guide chamber 222.

With the output end 318 flush with the guide chamber 222 and the irrigation guide 238 secured to the dental implant surgical template 210, as shown in FIG. 16 the dental implant surgical template may be positioned over the osteotomy site by securing the anchoring features 214 to the patient's anatomy, which in the illustrated example includes teeth 332 on either side of the osteotomy site. With the osteotomy site prepared and the dental implant surgical template 210 secured to the patient's anatomy, a source of irrigation fluid 336, such as surgical tubing connected to a source of saline, may be connected to the coupling end 246 of the irrigation guide 238, for example by positioning the tubing over surgical tubing over the rigid tubing 254. When irrigation fluid is supplied to the coupling end 246 of the irrigation guide 238 it flows through the irrigation channel 250, through the output end 318, and into the guide chamber 222 where it flows around and cools the osteotomy site while also flushing away drill debris such as bone particles. An osteotomy drill bit 340 is attached to the drill 264 and inserted through the guide sleeve 226 and into the guide chamber 222. The drill bit 340 may then be manipulated to perform the osteotomy procedure while being cooled with the irrigation fluid 336 provided to the guide chamber 222 by the irrigation guide 238.

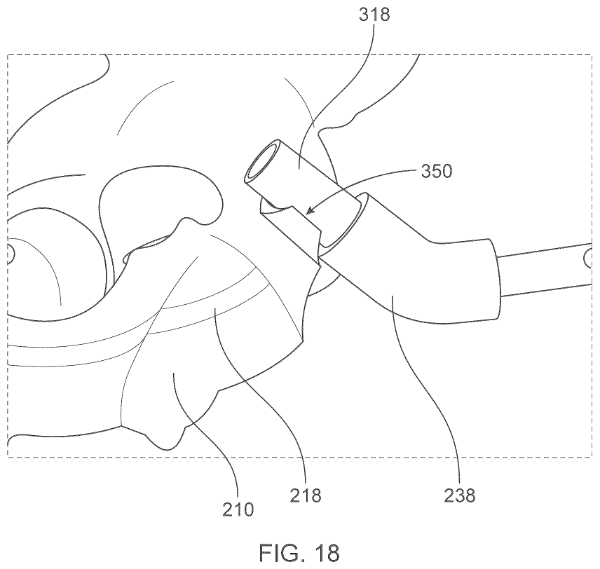

Referring to FIG. 18, in some applications, the dental implant surgical template 210 may be configured with a guide portion 218 that does not extend to fully cover or enclose the patient's anatomy, in which case there may be a gap or space between the patient's anatomy and the dental implant surgical template 210 and there may not be enough material in the guide portion 218 to form an irrigation passage 30 in the form of a cylindrical hole. In such applications, the drill bit 262 may be manipulated not in an axial direction, but in a lateral direction to form a depression or recess 350 in the dental implant surgical template 210 and oriented generally toward the osteotomy site. The output end 318 of the irrigation guide 238 may then be attached to the recess 350 using adhesive such that irrigation fluid flowing through the irrigation guide 238 is directed toward the osteotomy site.

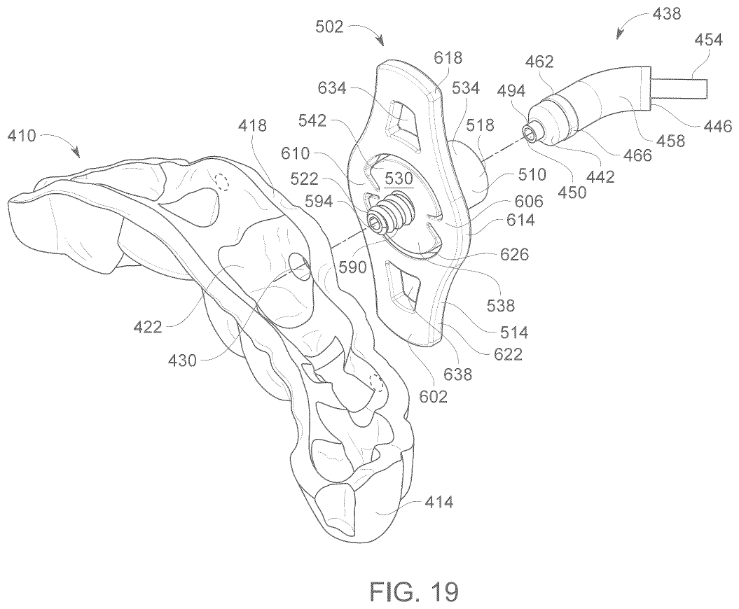

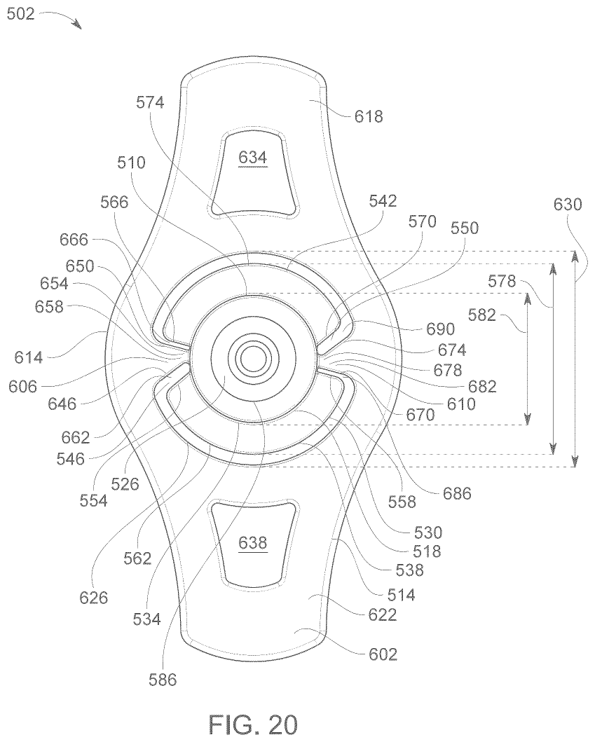

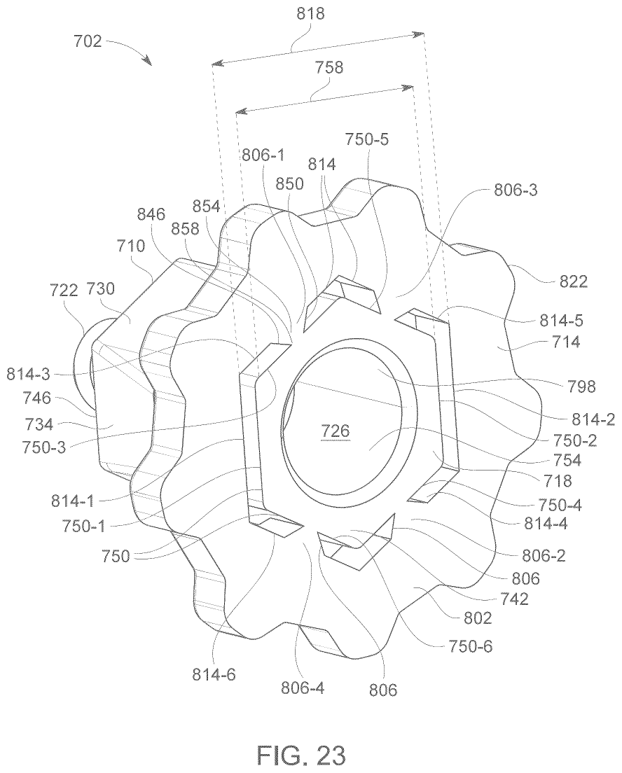

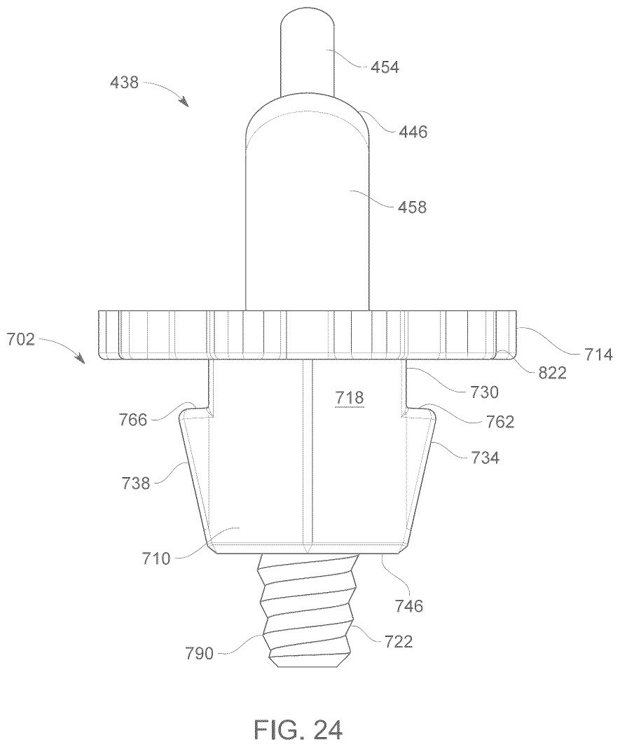

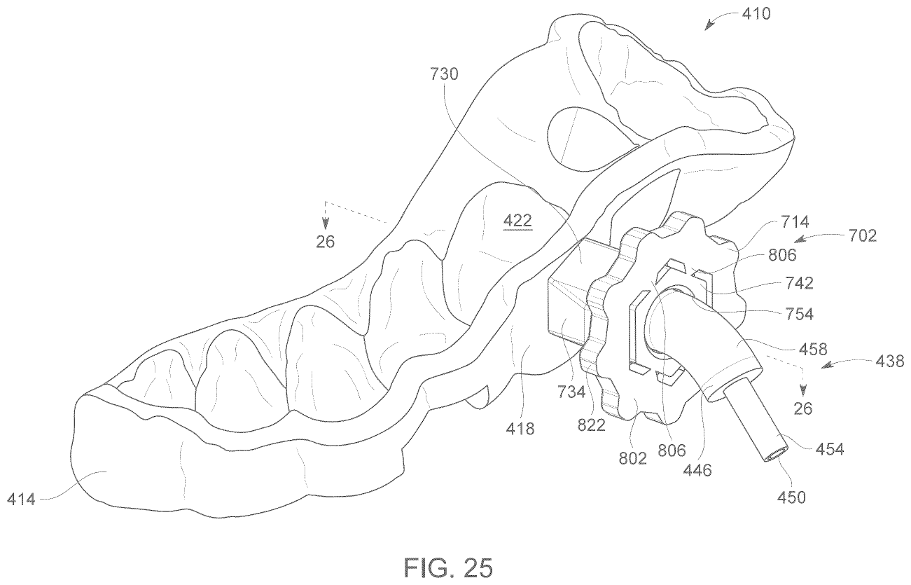

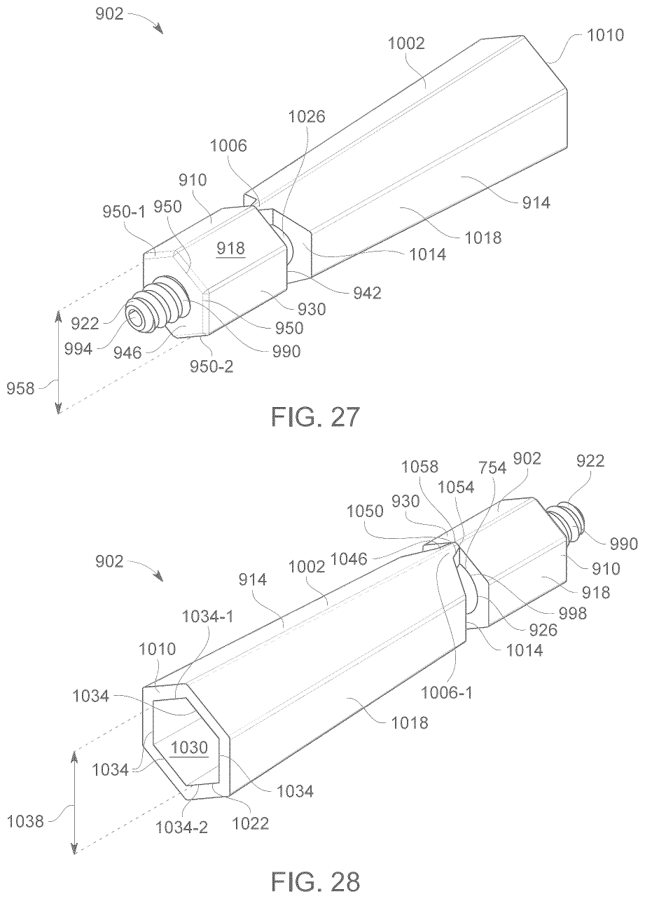

FIGS. 19-30 illustrate alternate embodiments for securing an irrigation guide 438 to a dental implant surgical template 410. FIGS. 19-22 illustrate an installation tool 502. FIGS. 23-26 illustrate an installation tool 702. FIGS. 27-30 illustrate an installation tool 902. Each of the described installation tools (e.g., installation tool 502, installation tool 702, and installation tool 902) enable the irrigation guide 438 to be removed from the dental implant surgical template 410 after completion of an osteotomy procedure (or whenever desired). Because the irrigation guide 438 is configured to be removably attached, rather than fixedly attached (e.g., via adhesive, as described above in connection with FIG. 14), the irrigation guide 438 may be re-used at other portions of the dental implant surgical template 410 or another dental implant surgical template (e.g., in scenarios when a patient requires multiple osteotomy procedures and/or the like).

It should be understood that the dental implant surgical template 410 may correspond to, or include one or more features of, the dental implant surgical template 10 or the dental implant surgical template 210, as described above. For example, in addition to including an anchoring feature 414 that is adapted for engagement with a patient's anatomy, the dental implant surgical template 410 includes a guide portion 418 having a guide chamber 422, a guide sleeve (not shown), and an irrigation passage 430, which may be formed by the drill bit 262 as described above in connection with FIGS. 11-12, or by an alternative drill bit having a diameter that is suitable for use with installation tools 502, 702, 902. Those skilled in the art will appreciate that when forming the irrigation passage 430 the drill bit 262 should be advanced only as far as needed to form a suitably sized irrigation passage 430. In some configurations, the drill bit 262 may include a positive stopping feature to prevent-advancing the drill bit 262 too deeply into the surgical template 410. In some cases, as described below, the dental implant surgical template 410 may include one or more additional guide portions having corresponding guide chambers, guide sleeves, and irrigation passages (e.g., as shown by dotted lines in FIG. 19).

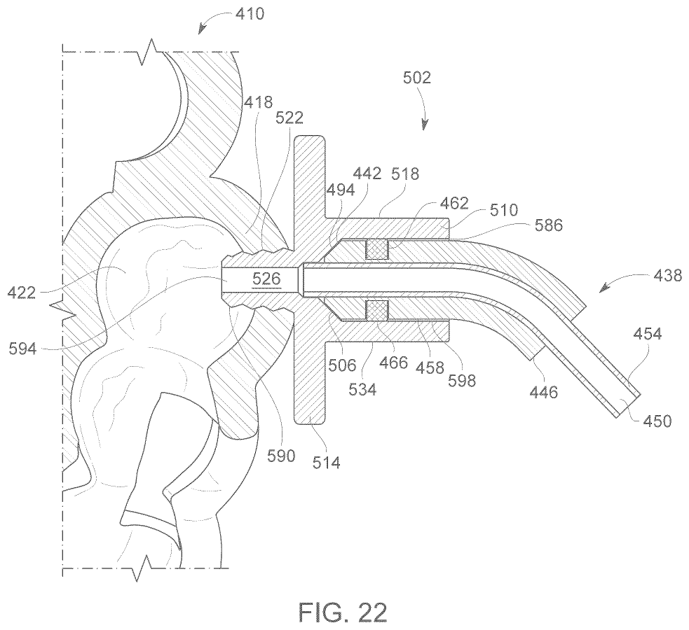

Referring to FIG. 19, the irrigation guide 438 includes a second interface surface 442, a coupling end 446, an irrigation channel 450 extending between the second interface surface 442 and the coupling end 446, and an outer surface 458 exterior to the irrigation channel 450 and extending along the length of the irrigation guide 438. The second interface surface 442 includes an output end 494, which may be cylindrical, frusto-conical, and/or the like, and is engageable with a first interface surface 506 of the installation tool 502 (e.g., as shown in FIG. 22) to secure the irrigation guide 438 to the first interface surface 506 and to place the irrigation channel 450 into fluid communication with the irrigation passage 430. The coupling end 446 includes a length of rigid tubing 454 (e.g., stainless steel) inserted therein that communicates with the irrigation channel 450. Although not shown, a distal end of the rigid tubing 454 may include a retention feature such as a barb, flare, luer lock, and/or the like for enhancing retention of a source irrigation fluid. The outer surface 458 includes a groove 462 that receives an o-ring 466 to provide a frictional engagement within the installation tool 502, which will be described in greater detail below.

Referring to FIGS. 19-22, the installation tool 502, which may be formed of a single, monolithic piece of material (e.g., polyethylene, polypropylene, acrylonitrile butadiene styrene (ABS), polyvinyl chloride (PVC), and/or the like), includes an installation tool body 510 and a handle 514 extending radially therefrom. The installation tool body 510 includes a receptacle 518, a projection 522 extending axially from the receptacle 518, and an installation tool passageway 526 extending through the receptacle 518 and the projection 522 to permit passage of the irrigation fluid from the irrigation guide 438 into the osteotomy site.

The receptacle 518 includes a base portion 530 and a cylindrical portion 534. The base portion 530 of the receptacle 518 includes a first arcuate member 538 and a second arcuate member 542 which are radially spaced apart to define a front indentation 546 and a rear indentation 550. The first arcuate member 538 includes a first front angled surface 554, a first rear angled surface 558, and a first arcuate surface 562 extending therebetween. The second arcuate member 542 likewise includes a second front angled surface 566, a second rear angled surface 570, and a second arcuate surface 574 extending therebetween. The first arcuate surface 562 and the second arcuate surface 574 together define a first diameter 578 of the base portion 530. The cylindrical portion 534 of the receptacle 518, which defines a second diameter 582 that is less than the first diameter 578, includes a first, upper opening 586 that defines an entrance of the installation tool passageway 526.

The projection 522 includes an outer threaded surface 590 and a second, lower opening 594 that defines an exit of the installation tool passageway 526. The outer threaded surface 590 is sized and shaped to permit the installation tool 502 to be threadably inserted into and held within the irrigation passage 430 of the dental implant surgical template 410, as will be described below.

The installation tool passageway 526 includes the first interface surface 506 and a cylindrical surface 598, which are shaped and sized to permit the irrigation guide 438 to be frictionally held within the installation tool passageway 526. In particular, the first interface surface 506 is shaped and sized to substantially correspond to the second interface surface 442 of the irrigation guide 438. The cylindrical surface 598, in turn, is shaped and sized to substantially correspond to the outer surface 458 of the irrigation guide 438 and to snugly receive the O-ring 466, which seals the passageway 526. In some configurations, the cylindrical surface 598 may be provided with a circumferential groove or recess that is located to receive the O-ring 466 when the irrigation guide 438 is fully seated within the passageway 526. The fit between the O-ring 466 and the cylindrical surface 598 is tight enough to secure the irrigation guide 438 within the passageway 526 while still allowing for rotation of the irrigation guide 438 within the passageway 526 so the user can orient the coupling end 446 of the irrigation guide 438 in the desired direction.

The handle 514 includes a handle body 602, a first frangible member 606, and a second frangible member 610. The handle body 602 includes a central portion 614, a first arm 618 extending from one side of the central portion 614, and a second arm 622 extending from the other side of the central portion 614. The central portion 614 includes a central aperture 626, which has a third diameter 630 that is larger than the first diameter 578 to permit the handle 514 to rotate relative to the installation tool body 510. In order to minimize material costs associated with manufacturing the installation tool 502, the first arm 618 may include a first aperture 634, and the second arm 622 may include a second aperture 638. In some configurations, the receptacle 518 and the apertures 634, 638 may be configured to have complimentary non-circular cross sections to permit the apertures to fit over the receptacle 518, thereby allowing the handle to be used to further tighten the receptacle 518 if desired for a particular application.

While the handle body 602 is shown as having an oblong, symmetrical shape, it should be understood that other shapes are possible. For example, the handle body 602 could alternatively have an asymmetrical shape, a rectangular shape, a circular shape, an oval shape, and/or the like. Furthermore, it should be understood that different quantities, shapes, and arrangements of apertures are possible as well.

The first frangible member 606, which projects from the central aperture 626, includes a first angled surface 646 and a second angled surface 650 that extend toward one another to form a substantially triangular shape having a rear-facing tip 654 that defines a first frangible connection 658 with the front indentation 546. The first frangible member 606 is positioned within the front indentation 546 such that the first angled surface 646 faces the first front angled surface 554 of the first arcuate member 538 and defines a first front gap 662 therebetween. The second angled surface 650, in turn, faces the second front angled surface 566 of the second arcuate member 542 and defines a second front gap 666 therebetween. A size of the first front gap 662 along a radial direction is larger than a size of the second front gap 666 along the radial direction.

The second frangible member 610, which projects from the central aperture 626, likewise includes a first angled surface 670 and a second angled surface 674 that extend toward one another to form a substantially triangular shape having a front-facing tip 678 that defines a second frangible connection 682 with the second indentation. The second frangible member 610 is positioned within the rear indentation 550 such that the first angled surface 670 faces the first rear angled surface 558 of the first arcuate member 538 and defines a first rear gap 686 therebetween. The second angled surface 674, in turn, faces the second rear angled surface 570 of the second arcuate member 542 and defines a second rear gap 690 therebetween. A size of the first rear gap 686 along the radial direction is substantially equal to the size of the second front gap 666. A size of the second rear gap 690 along the radial direction is substantially equal to the size of the first front gap 662.

To use the above-described embodiment, the user may insert the projection 522 of the installation tool 502 into the irrigation passage 430 of the dental implant surgical template 410, which was pre-formed using the drill bit 262 as described above in connection with FIGS. 11-12. To cause the projection 522 to threadably progress into the irrigation passage 430, the user may grip and apply a rotational force onto the handle 514 in a clockwise direction. By rotating the handle 514 clockwise, the user causes the second front gap 666 and the first rear gap 686 to close up, which in turn causes the second angled surface 650 of the first frangible member 606 to abut, and thus transfer the rotational force upon, the second front angled surface 566 of the second arcuate member 542, and causes the first angled surface 670 of the second frangible member 610 to abuts and transfer the rotational force onto the first rear angled surface 558 of the first arcuate member 538. Because the second front gap 666 and the first rear gap 686 are substantially radially aligned with the central axis of the base portion 530, the relatively small distance that the handle moves relative to the base portion 530 before the gaps 666, 686 close up does not generate significant strain on the first and second frangible connections 658, 682.

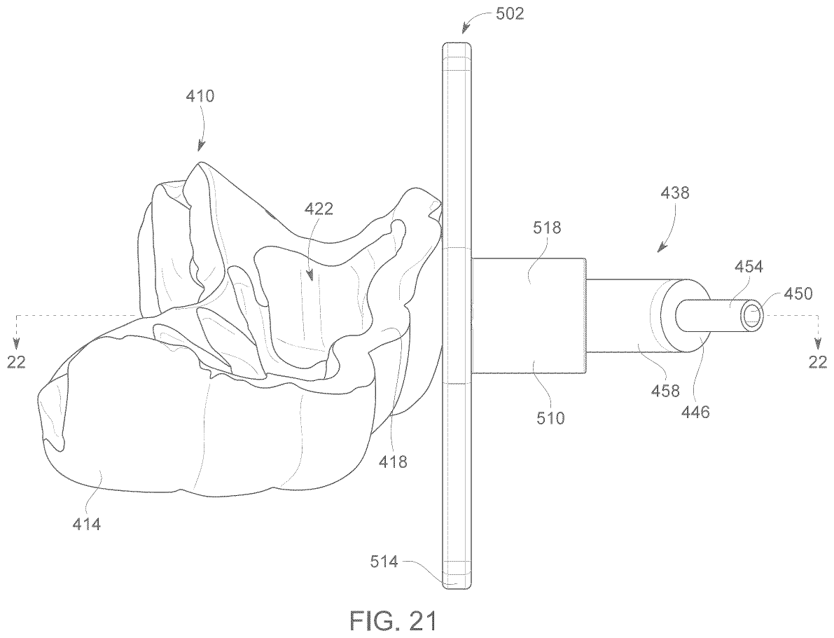

Once the projection 522 is secured within the irrigation passage 430 (e.g., as shown in FIG. 21), because the size of the handle 514 may prevent or otherwise hinder the user from accessing the osteotomy site, the user may remove the handle 514 from the installation tool 502 while leaving the installation tool body 510 in place within the irrigation passage 430. To do so, the user may grip and apply a rotational force onto the handle 514 in a counterclockwise direction. By rotating the handle 514 counterclockwise, the user causes the first angled surface 646 of the first frangible member 606 to rotate toward the first front angled surface 554 of the first arcuate member 538 through the first front gap 662. At the same time, the second angled surface 674 of the second frangible member 610 rotates toward the second rear angled surface 570 of the second arcuate member 542 through the second rear gap 690.

Because the first front gap 662 and the second rear gap 690 are larger, respectively, than the second front gap 666 and the first rear gap 686, and because the first front gap 662 and second rear gap 690 are radially misaligned from the central axis of the base portion 530, when the handle 514 is rotated in the counterclockwise direction it travels a greater distance relative to the body 510 before abutting the base portion 530 than when rotated in the clockwise direction, thereby significant strain on the first and second frangible connections 658, 682. As a result, an impact of the first angled surface 646 of the first frangible member 606 striking the first front angled surface 554 of the first arcuate member 538 causes the first frangible connection 658 to break, thereby separating the rear-facing tip 654 from the base portion 530. At the same time, an impact of the second angled surface 674 of the second frangible member 610 striking the second rear angled surface 570 of the second arcuate member 542 causes the second frangible connection 682 to also break, thereby separating the front-facing tip 678 from the base portion 530. In some configurations, the first angled surface 646 and the first front angled surface 554, and the second angled surface 674 and the second rear angled surface 570, may be configured (e.g. angled) to define cam surfaces so that when they contact one another an axial force is generated that tends to move the handle 514 axially relative to the base portion 530, thereby placing additional strain on the first and second frangible connections 658, 682 to further facilitate separation of the handle 514 from the base portion 530.

Depending on the thickness of the surgical template 410, in some applications, after installation of the installation tool body 510 into the surgical template 410, the end of the projection 522 may extend into the guide chamber 422. In such instances, to provide adequate clearance for the osteotomy drill bit, as described above with respect to FIG. 15, a burr 328 or similar attachment may be used in cooperation with the drill 264 to grind away the portion of the projection 522 that extends into the guide chamber 422 until the end of the projection 522 is substantially flush with the wall of the guide chamber 422.

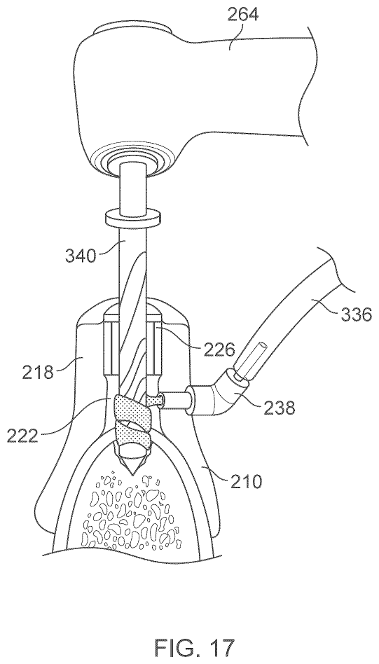

With the installation tool body 510 installed on the surgical template 410, a user may insert the surgical template 410 into the patient's mouth and secure it to the patient's anatomy to prepare for an osteotomy procedure. The user may then insert the output end 494 of the irrigation guide 438 into the upper opening 586 of the cylindrical portion 534 to frictionally secure the output end 494 of the irrigation guide 438 against the first interface surface 506. With the irrigation guide 438 firmly in place within the receptacle 518 the user may perform the osteotomy procedure as described above in connection with FIG. 17. For example, the user may insert the osteotomy drill bit 340, which has been attached to the drill 264, into the guide chamber 422 over the osteotomy site. The user may connect the source of irrigation fluid 336 to the coupling end 446 of the irrigation guide 438 to enable irrigation fluid to flow through the irrigation channel 450, along the installation tool passageway 526, and into the guide chamber 422. By introducing the irrigation fluid into the guide chamber, the user cools the osteotomy site while also flushing away drill debris and other particles.

While the above process sets forth an order of assembly that includes frictionally securing the irrigation guide 438 within the installation tool passageway 526 of the installation tool 502 after threadably attaching the installation tool 502 to the dental implant surgical template 410, it should be understood that this order of assembly may be reversed. In other words, the user may instead threadably attach the installation tool 502 to the dental implant surgical template 410 after the irrigation guide 438 is frictionally secured within the installation tool passageway 526 of the installation tool 502.

In some cases, a patient may require multiple osteotomy procedures. In such a case, in order to permit use of the irrigation guide 438 at different locations on the dental implant surgical template 410, or on another dental implant surgical template altogether, the user may use multiple installation tools 502 to install multiple installation tool bodies 510 into irrigation passages 430 formed at different locations of the surgical template 410, or into irrigation passages 430 on different surgical templates 410 that may be positioned in different areas of the patient's mouth. During the osteotomy procedure, after completing a drilling operation at one location, the user may quickly and easily remove the irrigation guide 438 from the installation tool passageway 526 of one installation tool body 510 and insert it into the installation tool passageway 526 of a different installation tool body 510 at the next location where an osteotomy procedure will be performed. The user may then continue moving the irrigation guide 438 between osteotomy locations until the entire procedure is completed.

Referring to FIGS. 23-26, the installation tool 702, which may be formed of a single, monolithic piece of material (e.g., polyethylene, polypropylene, acrylonitrile butadiene styrene (ABS), polyvinyl chloride (PVC), and/or the like), includes an installation tool body 710 and a handle 714 extending radially therefrom. The installation tool body 710 includes a receptacle 718, a projection 722 extending axially from the receptacle 718, and an installation tool passageway 726 extending through the receptacle 718 and the projection 722 to permit passage of the irrigation fluid from the irrigation guide 438 into the osteotomy site.

The receptacle 718 includes a receptacle body 730, a first shoulder 734, and a second shoulder 738. The receptacle body 730 includes a first, upper receptacle end surface 742, a second, lower receptacle end surface 746 opposite to the upper receptacle end surface 742, and six side surfaces 750 connecting the upper receptacle end surface 742 and the lower end receptacle end surface 746. The upper receptacle end surface 742 includes a first, upper opening 754 that defines an entrance of the installation tool passageway 726. The lower end receptacle end surface 746 has substantially the same shape and size as that of the upper receptacle end surface 742. A first side surface 750-1, of the six side surfaces 750, and an opposing second side surface 750-2, of the six side surfaces 750, together define a first width 758 of the receptacle body 730. The first shoulder 734 tapers away from the lower receptacle end surface 746 along the first side surface 750-1 and forms a first ledge 762 that is substantially perpendicular to the first side surface 750-1. The second shoulder 738 likewise tapers away from the lower receptacle end surface 746 along the second side surface 750-2 and forms a second ledge 766 that is substantially perpendicular to the second side surface 750-2.

While receptacle body 730 is shown as having a shape substantially in the form of a hexagonal prism (e.g., with the upper receptacle end surface 742 and the lower receptacle end surface 746 being hexagonal and the six side surfaces 750 being rectangular), it should be understood that other shapes are possible. For example, the receptacle body 730 could alternatively have an asymmetrical shape, a cylindrical shape, a rectangular prismatic shape, and/or the like. Furthermore, it should be understood that different quantities, shapes, and arrangements of shoulders are possible as well.

The projection 722, which may correspond to the projection 522, includes an outer threaded surface 790 and a second, lower opening 794 that defines an exit of the installation tool passageway 726. The outer threaded surface 790 is sized and shaped to permit the installation tool 702 to be threadably inserted into and held within the irrigation passage 430 of the dental implant surgical template 410, as will be described below.

The installation tool passageway 726, which may correspond to the installation tool passageway 526, includes a first interface surface 706 and a cylindrical surface 798, which are shaped and sized to permit the irrigation guide 438 to be frictionally held within the installation tool passageway 726. In particular, the first interface surface 706 is shaped and sized to substantially correspond to the second interface surface 442 of the irrigation guide 438. The cylindrical surface 798, in turn, is shaped and sized to substantially correspond to the outer surface 458 of the irrigation guide 438 and to snugly receive the O-ring 466, which seals the passageway 726. In some configurations, the cylindrical surface 798 may be provided with a circumferential groove or recess that is located to receive the O-ring 466 when the irrigation guide 438 is fully seated within the passageway 726. The fit between the O-ring 466 and the cylindrical surface 798 is tight enough to secure the irrigation guide 438 within the passageway 726 while still allowing for rotation of the irrigation guide 438 within the passageway 726 so the user can orient the coupling end 446 of the irrigation guide 438 in the desired direction.

The handle 714 includes a handle body 802 and four frangible members 806. The handle body 802 includes a central aperture 810 having six aperture sides 814. A first aperture side 814-1, of the six aperture sides 814, and an opposing second aperture side 814-2, of the six aperture sides 814, together define a second width 818 that is greater than the first width 758 to permit the handle 714 to move relative to the receptacle body 730. To facilitate gripping of the handle 714, the handle body 802 may include an undulating perimeter 822 or a similarly serrated edge.

The four frangible members 806, which are substantially identical, include a first frangible member 806-1, a second frangible member 806-2, a third frangible member 806-3, and a fourth frangible member 806-4. The first frangible member 806-1 frangibly connects a third aperture side 814-3, of the six aperture sides 814, to a third side surface 750-3, of the six side surfaces 750. The second frangible member 806-2 frangibly connects a fourth aperture side 814-4, of the six aperture sides 814, to a fourth side surface 750-4, of the six side surfaces 750. The third frangible member 806-3 frangibly connects a fifth aperture side 814-5, of the six aperture sides 814, to a fifth side surface 750-5, of the six side surfaces 750. The fourth frangible member 806-4 frangibly connects a sixth aperture side 814-6, of the six aperture sides 814, to a sixth side surface 750-6, of the six side surfaces 750.

For purposes of simplicity, the structure of the first frangible member 806-1 will be described below. It should be understood that the described structure applies to the second frangible member 806-2, the third frangible member 806-3, and the fourth frangible member 806-4 as well. The first frangible member 806-1 includes a first angled surface 846 and a second angled surface 850 that extend toward one another to form a substantially triangular shape. The first angled surface 846 and the second angled surface 850 converge at an inwardly-facing tip 854 that defines a frangible connection 858 with the receptacle body 730. To facilitate breaking the frangible connection 858, as will be described below, the inwardly-facing tip 854 may provide greater strength in a rotational direction than in an axial direction.

While the handle body 802 is shown as having a generally annular, symmetrical shape, it should be understood that other shapes are possible. For example, the handle body 802 could alternatively have an asymmetrical shape, a rectangular shape, a circular shape, and/or the like. Furthermore, it should be understood that different quantities, shapes, and arrangements of frangible members are possible as well.

To use the above-described embodiment, a user may insert the projection 722 of the installation tool 502 into the irrigation passage 430 of the dental implant surgical template 410, which was pre-formed using the drill bit 262 as described above in connection with FIGS. 11-12. To cause the projection 722 to threadably progress into the irrigation passage 430, the user may grip and apply a rotational force onto the handle 714 in a clockwise direction.

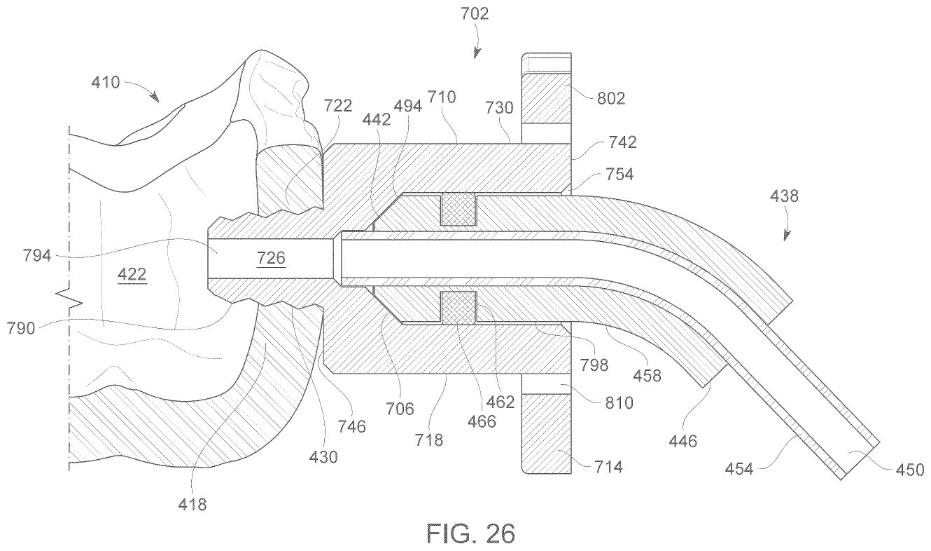

Once the projection 722 is fully secured within the irrigation passage 430 (e.g., as shown in FIG. 26), because the size of the handle 714 may prevent or otherwise hinder the user from accessing the osteotomy site, the user may remove the handle 714 from the installation tool 702 while leaving the installation tool body 710 in place within the irrigation passage 430. To do so, the user may apply an axial force onto the handle 714 in a direction toward the first ledge 762 and the second ledge 766. Because the frangible connection 858 is stronger in the rotational direction than the axial direction (e.g., due to one or more manufacturing techniques), the frangible connection 858 is configured to selectively break when the axial force is applied. As a result, the user may separate the four frangible members 806 from the receptacle body 730. The user may then discard the handle 714. By removing the handle 714 so that only the receptacle body 730 remains attached to the surgical template 410, additional space is created within the patient's mouth to facilitate performance of the osteotomy procedure. Alternatively, a user may separate the handle 714 from the receptacle body 730 before installing the receptacle body into the surgical template 410, and then use the handle 714 to thread the projection 722 into the irrigation passage 430.

Depending on the thickness of the surgical template 410, in some applications, after installation of the tool body 710 into the surgical template 410, the end of the projection 722 may extend into the guide chamber 422. In such instances, to provide adequate clearance for the osteotomy drill bit, as described above with respect to FIG. 15, a burr 328 or similar attachment may be used in cooperation with the drill 264 to grind away the portion of the projection 722 that extends into the guide chamber 422 until the end of the projection 722 is substantially flush with the wall of the guide chamber 422.

With the receptacle body 730 secured to the surgical template 410 and the handle 714 removed, the surgical template 410 may be positioned within the patient's mouth and secured to the patient's anatomy to prepare for an osteotomy procedure. The user may then insert the output end 494 of the irrigation guide 438 into the upper opening 754 to frictionally secure the output end 494 of the irrigation guide 438 against the first interface surface 706 of the installation tool passageway 726. With the irrigation guide 438 firmly in place within the installation tool 702, the user may perform the osteotomy procedure as described above in connection with FIG. 17. For example, the user may insert the osteotomy drill bit 340, which has been attached to the drill 264, into the guide chamber 422 over the osteotomy site. The user may connect the source of irrigation fluid 336 to the coupling end 446 of the irrigation guide 438 to enable irrigation fluid to flow through the irrigation channel 450, along the installation tool passageway 726, and into the guide chamber 422. By introducing the irrigation fluid into the guide chamber 422, the user cools the osteotomy site while also flushing away drill debris and other particles.

While the above process sets forth an order of assembly that includes frictionally securing the irrigation guide 438 within the installation tool passageway 726 after threadably attaching the installation tool 702 to the dental implant surgical template 410, it should be understood that this order of assembly may be reversed. In other words, the user may instead threadably attach the installation tool 702 to the dental implant surgical template 410 after frictionally securing the irrigation guide 438 within the installation tool passageway 726.

In some cases, a patient may require multiple osteotomy procedures. In such a case, in order to permit use of the irrigation guide 438 at different locations on the dental implant surgical template 410, or on another dental implant surgical template altogether, the user may use multiple installation tools 702 to install multiple installation tool bodies 710 into irrigation passages 430 formed at different locations of the surgical template 410, or into irrigation passages 430 on different surgical templates 410 that may be positioned in different areas of the patient's mouth. During the osteotomy procedure, after completing a drilling operation at one location, the user may quickly and easily remove the irrigation guide 438 from the installation tool passageway 726 of one installation tool body 710 and insert it into the installation tool passageway 726 of a different installation tool body 710 at the next location where an osteotomy procedure will be performed, in the manner described above. The user may then continue moving the irrigation guide 438 between osteotomy locations until the entire procedure is completed.

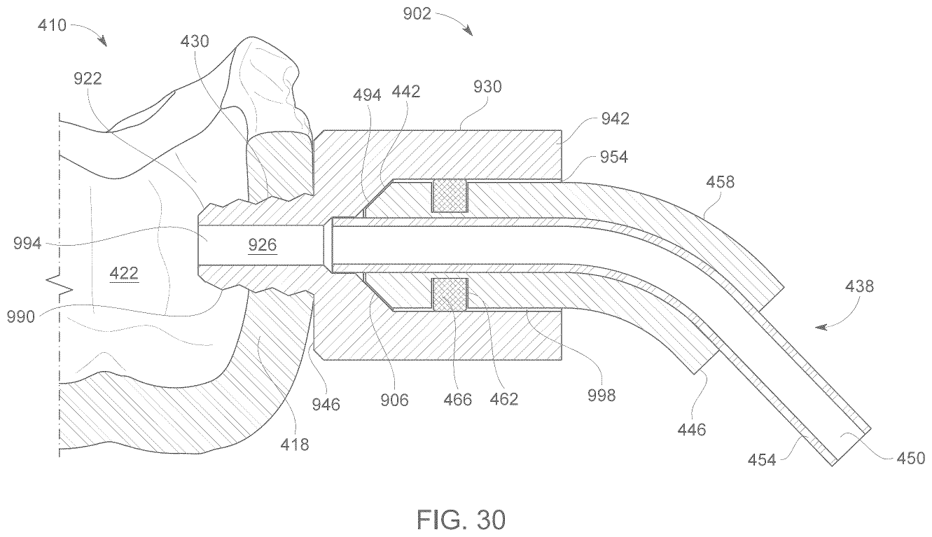

Referring to FIGS. 27-30, the installation tool 902, which may be formed of a single, monolithic piece of material (e.g., polyethylene, polypropylene, acrylonitrile butadiene styrene (ABS), polyvinyl chloride (PVC), and/or the like), includes an installation tool body 910 and a handle 914 extending axially therefrom. The installation tool body 910 includes a receptacle 918, a projection 922 extending axially from the receptacle 918, and an installation tool passageway 926 (FIG. 30) extending through the receptacle 918 and the projection 922 to permit passage of the irrigation fluid from the irrigation guide 438 into the osteotomy site.

The receptacle 918 includes a receptacle body 930 having a first, upper receptacle end surface 942, a second, lower receptacle end surface 946 opposite to the upper receptacle end surface 942, and six side surfaces 950 connecting the upper receptacle end surface 942 and the lower receptacle end surface 946. The upper receptacle end surface 942 includes a first, upper opening 954 that defines an entrance of the installation tool passageway 926. The lower receptacle end surface 946 has substantially the same shape and size as that of the upper receptacle end surface 942. A first side surface 950-1, of the six side surfaces 950, and an opposing second side surface 950-2, of the six side surfaces 950, together define a first width 958 of the receptacle body 930.

While receptacle body 930 is shown as having a shape substantially in the form of a hexagonal prism (e.g., with the upper receptacle end surface 942 and the lower receptacle end surface 946 being hexagonal and the six side surfaces 950 being rectangular), it should be understood that other shapes are possible. For example, the receptacle body 930 could alternatively have an asymmetrical shape, a rectangular prismatic shape, and/or the like.

The projection 922, which may correspond to the projection 522 or to the projection 722, includes an outer threaded surface 990 and a second, lower opening 994 that defines an exit of the installation tool passageway 926. The outer threaded surface 990 is sized and shaped to permit the installation tool 902 to be threadably inserted into and held within the irrigation passage 430 of the dental implant surgical template 410, as will be described below.

The installation tool passageway 926, which may correspond to the installation tool passageway 526 or the installation tool passageway 726, includes a first interface surface 906 and a cylindrical surface 998, which are shaped and sized to permit the irrigation guide 438 to be frictionally held within the installation tool passageway 926. In particular, the first interface surface 906 is shaped and sized to substantially correspond to the second interface surface 442 of the irrigation guide 438. The cylindrical surface 998, in turn, is shaped and sized to substantially correspond to the outer surface 458 of the irrigation guide 438 and to snugly receive the O-ring 466, which seals the passageway 926. In some configurations, the cylindrical surface 998 may be provided with a circumferential groove or recess that is located to receive the O-ring 466 when the irrigation guide 438 is fully seated within the passageway 926. The fit between the O-ring 466 and the cylindrical surface 998 is tight enough to secure the irrigation guide 438 within the passageway 926 while still allowing for rotation of the irrigation guide 438 within the passageway 926 so the user can orient the coupling end 446 of the irrigation guide 438 in the desired direction.

The handle 914 includes an elongated handle body 1002 and a pair of frangible members 1006. The elongated handle body 1002 includes a first, upper handle surface 1010, a second, lower handle surface 1014, and an outer handle surface 1018 connecting the upper handle surface 1010 to the lower handle surface 1014. The upper handle surface 1010 includes a first hexagonal opening 1022. The lower handle surface 1014 includes a second hexagonal opening 1026 that communicates with the first hexagonal opening 1022 to define a hexagonal passage 1030 having six passage sides 1034. A first passage side 1034-1, of the six passage sides 1034, and an opposing second passage side 1034-2, of the six passage sides 1034, together define a second width 1038 of the hexagonal passage 1030 that is slightly larger than the first width 958 of the receptacle body 930 to enable the hexagonal passage 1030 to fit over the receptacle body 930 such that the handle 914 can be used to rotate the receptacle body 930, as will be described below.

The pair of frangible members 1006, which are substantially identical, include a first frangible member 1006-1 and a second frangible member 1006-2 that axially project from opposite sides of the lower handle surface 1014 to frangibly connect to the upper receptacle end surface 942 of the receptacle body 930.

For purposes of simplicity, the structure of the first frangible member 1006-1 will be described below. It should be understood that the described structure applies to the second frangible member 1006-2 as well. The first frangible member 1006-1 includes a first angled surface 1046 and a second angled surface 1050 that extend toward one another to form a substantially triangular shape. The first angled surface 1046 and the second angled surface 1050 converge at a downwardly-facing tip 1054 that defines a frangible connection 1058 with the receptacle body 930.

While the handle 914 is shown as having the hexagonal passage 1030, it should be understood that other shapes of the passage are possible, so long as the shape of the passage substantially corresponds to the shape of the receptacle body 930. For example, the hexagonal passage 1030 could alternatively have an asymmetrical shape, a rectangular shape, and/or the like. Furthermore, it should be understood that different quantities, shapes, and arrangements of frangible members are possible as well.

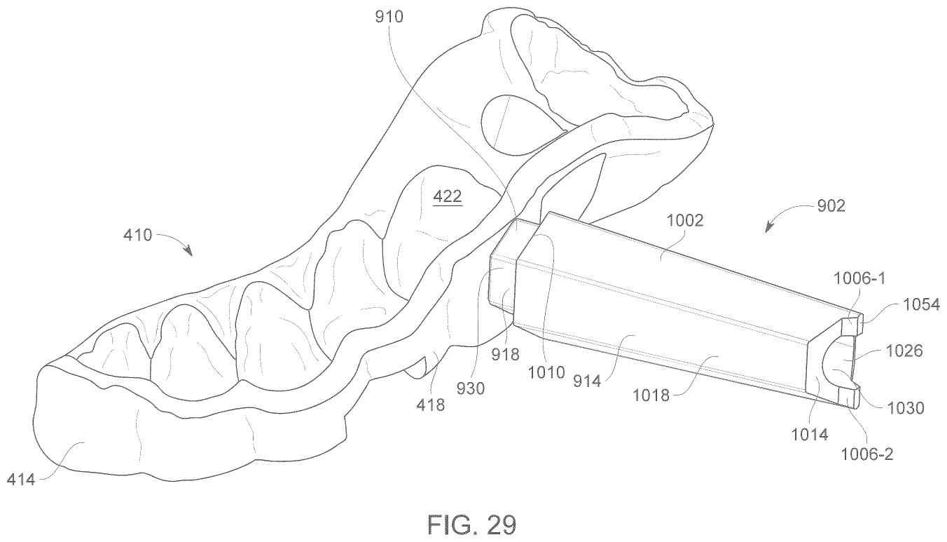

To use the above-described embodiment, a user may apply a force in a lateral direction to the handle 914 to cause the lower handle surface 1014 to move toward the upper receptacle end surface 942. Because the frangible connection 1058 is configured to selectively break when sufficient force is applied, the user may separate the handle 914 from the receptacle body 930 by moving the handle 914 relative to the receptacle body until the frangible members 1006 fracture and separate from the receptacle body 930. The user may then flip the handle 914 relative to the receptacle 918 and install the handle 914 over the receptacle 918, thereby causing the upper receptacle end surface 942 of the receptacle body 930 to enter the hexagonal passage 1030 of the handle 914 through the first hexagonal opening 1022. With the handle 914 so engaged (e.g., as shown in FIG. 29), the user may then rotate the handle 914 in the clockwise direction to cause the projection 922 to threadably progress into the irrigation passage 430. In other words, the user may use the handle 914, once separated from the receptacle 918, as a screwdriver to threadably secure the installation tool body 910 to the dental implant surgical template 410. Alternatively, a user may leave the handle 914 attached to the receptacle body 930 during the initial threaded installation of the projection 922 into the surgical template 410. Once the projection 922 is fully or partially threaded into the irrigation passage 430, the handle 914 may be separated from the receptacle body 930 as described above, turned around, installed over the receptacle 918, and used to further tighten the projection 922 into the irrigation passage 430 if desired.

With the installation tool body 910 secured to the dental implant surgical template 410, the user may remove the handle 914 from engagement with the receptacle 918 and discard the handle 914. Depending on the thickness of the surgical template 410, in some applications, after installation of the tool body 910 into the surgical template 410, the end of the projection 922 may extend into the guide chamber 422. In such instances, to provide adequate clearance for the osteotomy drill bit, as described above with respect to FIG. 15, a burr 328 or similar attachment may be used in cooperation with the drill 264 to grind away the portion of the projection 922 that extends into the guide chamber 422 until the end of the projection 922 is substantially flush with the wall of the guide chamber 422.

The surgical template 410 may then be positioned within the patient's mouth and secured to the patient's anatomy to prepare for an osteotomy procedure. The user may then insert the output end 494 of the irrigation guide 438 into the upper opening 954 of the installation tool passageway 926 to frictionally secure the output end 494 of the irrigation guide 438 against the first interface surface 906.

With the installation tool body 910 and the irrigation guide 438 secured to the dental implant surgical template 410 (e.g., as shown in FIG. 30), the user may perform the osteotomy procedure as described above in connection with FIG. 17. For example, the user may insert the osteotomy drill bit 340, which has been attached to the drill 264, into the guide chamber 422 over the osteotomy site. The user may connect the source of irrigation fluid 336 to the coupling end 446 of the irrigation guide 438 to enable irrigation fluid to flow through the irrigation channel 450, along the installation tool passageway 926, and into the guide chamber 422. By introducing the irrigation fluid into the guide chamber 422, the user cools the osteotomy site while also flushing away drill debris and other particles.

In some cases, a patient may require multiple osteotomy procedures. In such a case, in order to permit use of the irrigation guide 438 at different locations on the dental implant surgical template 410, or on another dental implant surgical template altogether, the user may use multiple installation tools 902 to install multiple installation tool bodies 910 into irrigation passages 430 formed at different locations of the surgical template 410, or into irrigation passages 430 on different surgical templates 410 that may be positioned in different areas of the patient's mouth. During the osteotomy procedure, after completing a drilling operation at one location, the user may quickly and easily remove the irrigation guide 438 from the installation tool passageway 926 of one installation tool body 910 and insert it into the installation tool passageway 926 of a different installation tool body 910 at the next location where an osteotomy procedure will be performed, in the manner described above. The user may then continue moving the irrigation guide 438 between osteotomy locations until the entire procedure is completed.

The dental implant surgical template 410, the irrigation guide 438, and one or more of the installation tool 502, 702, 902, or a combination of the installation tools 502, 702, 902, may be provided together in common packaging to form an alternative implant osteotomy kit. Additionally, or alternatively, the implant osteotomy kit may include the drill bit 262.

Each of the above-described exemplary installation tools 502, 702, 902 is configured to be provided as a single, unitary piece that includes the installation tool body 510, 710, 910 with the installation tool handle 514, 714, 914 frangibly connected to its respective installation tool body 510, 710, 910. In each exemplary configuration, the handle 514, 714, 914 is configured to provide the user with a greater mechanical advantage when installing the body 510, 710, 910 into the surgical template 410. The frangible connection between the handle 514, 714, 914 and the installation tool body 510, 710, 910, allows the handle 514, 714, 914 to be separated from the body 510, 710, 910 and discarded after the body 510, 710, 910 has been fully installed into the surgical template 410, thereby leaving additional room in the patient's mouth for performing the osteotomy procedure.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, spatially relative terms, such as “below,” “lower,” “above,” “upper,” and the like may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (e.g., rotated 90 degrees or at other orientations) and the spatially relative descriptors used herein may likewise be interpreted accordingly.

Various features of the invention are set forth in the following claims.

1. An installation tool for connecting an irrigation guide to a dental implant surgical template, the installation tool comprising:
a receptacle having a first opening;
a handle frangibly connected to the receptacle;
a threaded projection having a second opening and extending axially from the receptacle, the threaded projection being configured to threadably engage an irrigation passage in the dental implant surgical template; and
a passageway extending between the first opening of the receptacle and the second opening of the threaded projection, the passageway including a first interface surface that is configured to engage a second interface surface of the irrigation guide to frictionally secure the irrigation guide within the passageway.

2 The installation tool of claim 1, wherein the handle includes a frangible member having a first angled surface converging toward a second angled surface.

3. The installation tool of claim 2, wherein the handle includes a handle body having a central aperture, and wherein the frangible member projects inwardly from the central aperture toward the receptacle.

4. The installation tool of claim 2, wherein the receptacle includes a first arcuate member and a second arcuate member that are radially spaced apart to define an indentation therebetween, and wherein the frangible member is connected to the receptacle at a location within the indentation.

5. The installation tool of claim 2, wherein the receptacle includes a shoulder that tapers away from an end surface of the receptacle to form a ledge, and wherein the frangible member is connected to a side surface of the receptacle at a location above the ledge.

6. The installation tool of claim 2, wherein the frangible member axially projects from a handle surface that faces the receptacle and frangibly connects to a receptacle surface that faces the handle.

7. A kit for irrigating a dental implant surgical template, the dental implant surgical template including a guide chamber adapted to receive a surgical drill, and an irrigation passage communicating with the guide chamber, the kit comprising:
an installation tool including:
a receptacle having a first opening,
a handle frangibly connected to the receptacle,
a projection having a second opening and extending axially from the receptacle, the projection being configured to engage the irrigation passage, and
a passageway providing fluid communication between the first opening and the second opening, the passageway including a first interface surface; and an irrigation guide including:
a first end including a second interface surface,
a coupling end opposite the first end, and
an irrigation channel extending between the first end and the coupling end,
wherein the second interface surface is engageable with the first interface surface to secure the irrigation guide to the first interface surface and to place the irrigation channel into fluid communication with the guide chamber, and wherein the coupling end is coupleable to a source of irrigation fluid for providing irrigation fluid to the irrigation channel and the guide chamber.

8. The kit of claim 7, wherein the second interface surface fits within the first interface surface to secure the irrigation guide to the first interface surface.

9. The kit of claim 7, wherein the coupling end is angled relative to the first end, and wherein the irrigation guide is rotatable within the passageway to permit orientation of the coupling end relative to the first end.

10. The kit of claim 7, wherein the coupling end includes a length of rigid tubing in communication with the irrigation channel, and wherein the rigid tubing includes a retention feature at a distal end thereof.

11. The kit of claim 7, wherein the handle is frangibly connected to the receptacle of the installation tool body via a frangible member that includes a first angled surface converging towards a second angled surface.

12. The kit of claim 7, wherein the projection includes an outer threaded surface that is sized and shaped to permit the installation tool to be threadably inserted into and held within the irrigation passage.

13. The kit of claim 7, further comprising a second installation tool, the second installation tool including:
a second receptacle having a second receptacle first opening,
a second handle frangibly connected to the second receptacle,
a second projection having a second projection second opening and extending axially from the second receptacle, the second projection being configured to engage a second irrigation passage in the dental implant surgical template that communicates with a second guide chamber of the dental implant surgical template, and
a second passageway extending between the second receptacle first opening and the second projection second opening.

14. The kit of claim 7, further comprising the dental implant surgical template, wherein the dental implant surgical template further includes:
at least one anchoring feature adapted for engagement with anatomy of a patient, and
a second guide chamber adapted to receive the surgical drill.

15. A method of irrigating at least one osteotomy site, the method comprising:
providing a dental implant surgical template including an anchoring feature adapted for engagement with anatomy of a patient, and a guide portion coupled to the anchoring feature and defining a guide chamber;
providing an installation tool including a receptacle having a first opening, a handle frangibly connected to the receptacle, a projection having a second opening and extending axially from the receptacle, and a passageway extending between the first opening and the second opening, the passageway including a first interface surface;
providing an irrigation guide including a second interface surface, a coupling end, and an irrigation channel extending between the second interface surface and the coupling end;
forming an irrigation passage in the dental implant surgical template that fluidly communicates with the guide chamber;
inserting the projection into the irrigation passage to secure the installation tool to the dental implant surgical template;
inserting the irrigation guide into the passageway of the installation tool to engage the second interface surface with the first interface surface and to place the irrigation channel into fluid communication with the guide chamber; and
coupling the coupling end to a source of irrigation fluid to the deliver irrigation fluid to the guide chamber via the irrigation channel.

16. The method of claim 15, wherein inserting the projection into the irrigation passage includes rotating the handle of the installation tool.

17. The method of claim 15, further comprising frictionally securing the irrigation guide to the dental implant surgical template.

18. The method of claim 15, further comprising providing a drill bit, and wherein forming the irrigation passage includes forming the irrigation passage using the drill bit.

19. The method of claim 15, wherein the dental implant surgical template further comprises a second guide portion coupled to the anchoring feature and defining a second guide chamber, wherein the installation tool is a first installation tool, wherein the passageway is a first passageway, and wherein the method further comprises:
forming a second irrigation passage in the dental implant surgical template that fluidly communicates with the second guide chamber;
providing a second installation tool including a second receptacle, a second handle frangibly connected to the second receptacle, a second projection extending axially from the second receptacle, and a second passageway extending through the second receptacle and the second projection;
inserting the second projection into the second irrigation passage to place the second passageway into fluid communication with the second guide chamber;
removing the irrigation guide from the first passageway of the first installation tool; and
inserting the irrigation guide into the second passageway to place the irrigation channel into fluid communication with the second guide chamber.

20. The method of claim 15, further comprising separating the handle from the receptacle of the installation tool by breaking at least one frangible connection therebetween.
